(19) United States
(12) Patent Application Publication
(10) Pub. No.: US 2023/0342794 A1
(43) Pub. Date: Oct. 26, 2023

(54) METHODS AND APPARATUS FOR ADAPTIVE, INTEGRATED MYCOTECTURE FOR RAPID DEPLOYMENT AND SCALEUP

(71) Applicants: Massachusetts Institute of Technology, Cambridge, MA (US); Standard Bank Group Limited, Johannesburg (ZA)

(72) Inventors: Andreas Mershin, Cambridge, MA (US); Christopher Maurer, Cleveland Heights, OH (US); Carolyn Margaret Cameron-Kirksmith, Johannesburg (ZA); Yang Gao, Johannesburg (ZA)

(73) Assignees: Massachusetts Institute of Technology, Cambridge, MA (US); Standard Bank Group Limited, Johannesburg (ZA)

(21) Appl. No.: 18/344,483

(22) Filed: Jun. 29, 2023

Related U.S. Application Data
(63) Continuation-in-part of application No. 17/648,105, filed on Jan. 14, 2022.
(60) Provisional application No. 63/479,452, filed on Jan. 11, 2023.
(60) Provisional application No. 63/137,608, filed on Jan. 14, 2021.

(51) Int. Cl. G06Q 30/0201; G06Q 50/04

(52) U.S. Cl. CPC G06Q 30/0201; G06Q 50/04

(57) ABSTRACT

A data collection and analysis method aligns data across processes and products. The method includes collecting data in real time; mapping the data to a matrix between function and data points; and multiplexing the data. An integrated manufacturing process of a plurality of intermediate and final products from mycelium includes collecting data from the system at intervals; analyzing the data; iteratively optimizing the manufacturing process from the processed data; and generating environmental certifications from the processed data. An adaptive, unified mycotecture platform in conjunction with a digital recording and analysis system monitors and iteratively optimizes growth, harvest, packaging, quality control, and payment. The platform includes a manufacturing facility(ies) having a growing section, a storage section, and a manufacturing section. The facility has one or more of sensors, rapid-deploy scaffolding, a reconfigurable press, a brick extractor, a mixer, an autoclave, a laboratory, bar coding, and an interactive software application.

### CROSS-REFERENCE TO RELATED APPLICATION

This application claims the benefit of priority of U.S. provisional application No. 63/479,452, filed Jan. 11, 2023, the contents of which are herein incorporated by reference.

### BACKGROUND OF THE INVENTION

The present invention relates to agriculturally produced building materials, foods, and medicines and, more particularly, to methods and an apparatus for adaptive, integrated mycotecture for rapid deployment and setup. The methods are tripartite in nature and are tunable.

Mushrooms grow quickly on agricultural waste (agriwaste) without sunlight or extensive irrigation, making nutritious, high-protein, high nutrition foods. Alternatively and depending on species of mushroom and post-harvest processing, powder for brewed drinks and/or medicinal suspensions, salves, and tinctures are achieved starting from a common fundamental process. Mycelium, the vegetative form of fungi also seen as the “root system” of mushrooms having rootlike branching hyphae that consume lignocellulosic biomass, is the organism that produces mushrooms in a stage called “fruiting”. Mycelium secretes enzymes that digest their food and bond with the substrate at a cellular level, creating an organic binder. Some species of mycelium have also been shown to be useful for bioremediation of oil spills, toxic chemicals, acidic, basic and even radioactive waste, and for quickly breaking down plastics such as polyester polyurethane.

International markets exist, and global demand is growing, for mushroom-based foods (mycofoods) and medicines across an increasing variety of species. Mycofoods may be used to address the ever-increasing problem of malnutrition in Sub-Saharan Africa and beyond. Malnutrition-related diseases increase entirely preventable healthcare costs that span the entire lifetime of those malnutritioned at youth, causing socio-economic losses and needlessly lower the region's gross domestic product. The problem of malnutrition is exacerbated by homelessness.

Mycofoods are nutritional powerhouses already shown capable of being grown on limited square footage using up to two orders of magnitude less water, energy, and time than beef or corn of similar nutritional value (by weight post-dehydration). Mushrooms have a nutritional value that some consider qualifies mushrooms as (super)foods. For example, an oyster mushroom uses 3 L water to produce a gram of protein. A serving of oyster mushroom provides 0.4 g fat, 6.5 g carbohydrates, 2.3 g fiber, and 3.3 g protein for 43 calories. In contrast, ground beef uses 52 L water to produce a gram of protein. A serving of ground beef provides 17.4 g fat, no carbohydrates or fiber, and 27 g protein for 272 calories. Also, important benefits arise from the fact that mushrooms create edible biomass much faster than animals (oyster mushrooms for instance fruit within 21 days and within 3 cycles can create an equal wet weight of edible mushroom as the starting weight of the substrate). Chickpeas and rice require even more water to produce a gram of protein, at 114 L and 79 L of water per gram of protein, respectively. The prior art is replete with research on the nutritional value of mushrooms. Popović, et al. (“The effect of multiple nutrients on plasma parathyroid hormone level in healthy individuals”, International Journal of Food Sciences and Nutrition, 2019, Vol. 70, No. 5, pp. 638-644) included mushrooms in a study of Plasma parathyroid (PTH) levels in healthy adults and found that there is a positive relationship between diets with mushrooms and plasma PTH levels. Yahia, et al. (“Identification of phenolic compounds by liquid chromatography-mass spectrometry in seventeen species of wild mushrooms in Central Mexico and determination of their antioxidant activity and bioactive compounds”, Food Chemistry, 1 Jul. 2017, Vol. 226, pp. 14-22) breaks down 17 different species of wild mushrooms in search of phenolic compounds to assess their antioxidant properties. Sande, et al. (“Edible mushrooms as a ubiquitous source of essential fatty acids”, Food Research International, 2019, 125, 108524) reports on the use of mushrooms as a source of essential fatty acids.

Mushrooms have also been known for other uses, such as the use of ember fungus to transport fire. Mushrooms may also be used as a source of enzymes, for example to remove stains, and may be a source of components for cosmetics, as well as medicinal preparations, particularly prevalent in the practices of many traditions in Eastern medicine as well as modern nutrition-based wellness protocols.

Concurrently, “mycotecture”, a fast-emerging suite of processes, produces inexpensive, high-performance materials for housing, packaging, and insulation, with edible mushrooms being a natural byproduct of these processes. Self-sustaining or even “self-reproducing” shelter construction and food-production infrastructure is of general interest to all geographic regions. Ecovative and a handful of similar US, European, and New Zealand companies involved in mycotecture are solely focused on materials production and scaling up mushroom growth that is not ideal for food production. For example, a New Zealand startup is focused on producing mycotecture packaging material replacements for Styrofoam without food production. Even so, ice boxes and coolers are currently largely made of plastic-based material which is not environmentally friendly and is difficult to dispose of at the end of its useful life. Mycelium composites have been evaluated by Elise Elsacker, Simon Vandelook, Joost Brancart, Eveline Peeters, and Lars De Laet: “Mechanical, physical and chemical characterisation of mycelium-based composites with different types of lignocellulosic substrates” (2019), PLOS ONE; and by Mitchell Jones, Andreas Mautner, StefanoLuenco, Alexander Bismarck: “Engineered mycelium composite construction materials from fungal biorefineries: A critical review” (2020), Materials & Design Volume 18.

To date, mycofood production, mycotecture, and any related products and industries have been independently developed without optimizing interrelated processes. One-off, single-end point applications such as mushroom production only or materials production only have been shown before. The impact on or benefit to the environment has also not been interactively managed or iteratively optimized using available blockchain-backed real-time data collection to inform process management.

As can be seen, there is a need for a multifaceted approach to managing interrelated mycelium-based intermediate and final products, as well as their methods of production and end uses.

The methods and technology disclosed here represent a significant departure from prior work in both approach and function.

### SUMMARY OF THE INVENTION

In one aspect of the present invention, a data collection and analysis method operative to align data across processes and products comprises collecting data in real time; mapping the data to a matrix between function and data points; and multiplexing the data.

In another aspect of the present invention, an integrated manufacturing process of a plurality of intermediate and final products from mycelium comprises collecting data from the system at intervals; analyzing the data; iteratively optimizing the manufacturing process from the processed data; and generating environmental certifications from the processed data.

In yet another aspect of the present invention, an adaptive, unified mycotecture platform in conjunction with a digital recording and analysis system operative to monitor and iteratively optimize growth, harvest, packaging, quality control, and payment comprises at least one manufacturing facility having a growing section, a storage section, and a manufacturing section, the facility having one or more components selected from the group consisting of sensors, rapid-deploy scaffolding, a reconfigurable press, a brick extractor, a mixer, an autoclave, a laboratory, bar coding, and an interactive software application.

These and other features, aspects and advantages of the present invention will become better understood with reference to the following drawings, description, and claims.

### BRIEF DESCRIPTION OF THE DRAWINGS

FIG. 1 is a schematic view of an integrated data management system according to an embodiment of the present invention;

FIG. 2 is a flow diagram of steps in the mycotecture production process of FIG. 1;

FIG. 3 is a continuation of the flow diagram of FIG. 2;

FIG. 4A is a schematic view thereof, presented as a process map;

FIG. 4B is a continuation of the process map of FIG. 4A;

FIG. 5 is a screenshot of an app user interface according to an embodiment of the present invention;

FIG. 6 is a graphical view of data collected therewith;

FIG. 7 is a schematic view of a data insight report produced thereby;

FIG. 8 is a plan view of a facility operating a method according to an embodiment of the present invention;

FIG. 9 is a perspective view of a growing tunnel thereof;

FIG. 10 is an exploded detail view thereof, showing a cart system therein;

FIG. 11 is an exploded view of a prefabricated home comprising mycotecture-derived building materials according to a method of the present invention.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

As used herein, the term “mycotecture” refers to building, packaging, and insulative materials, as well as potentially dual-purpose materials including edible or medicinal materials, comprising cultivated mycelium, including construction materials for housing, packaging, and insulation, and architectural structures constructed therefrom. The mycotecture methods and apparatus described herein are sometimes referred to as BioHab or BioFab self-sustaining self-reproducing housing or as MycoHab (the prefix myco- is intended to indicate the common origin in fungi for the variety of end products).

Broadly, one embodiment of the present invention is a novel, adaptive, generalizable to climate, agricultural, and geological condition, unified mycotecture platform applied in conjunction with a digital recording and analysis system. The system is operative to monitor and iteratively adapt/optimize growth, harvest, packaging, quality control, and documentation for payment for ecosystems services. The platform may utilize compatible equipment, including Internet of Things sensors; inflatables as rapid-deploy scaffolding; a reconfigurable press for variable geometry materials; and a brick extractor. Embodiments of the present invention include an integrated workflow process for substrate pasteurization, spawn production, and heat delivery to allow form, stiffness, strength, and shape selection via an iterative, digitally-informed optimization of material properties process.

The present subject matter marks a continuation of the disclosure of U.S. patent application Ser. No. 17/648,105, filed Jan. 14, 2022, which is incorporated by reference herein in its entirety.

Mycelium is a substantially infinitely renewable resource. One kg of agriwaste over about 63 days may be converted into 1 kg mushrooms and 1 kg structural material, while binding 1.5 kg carbon equivalent. The structural materials may be considered an “antiplastic”, replacing non-biodegradable products currently in use.

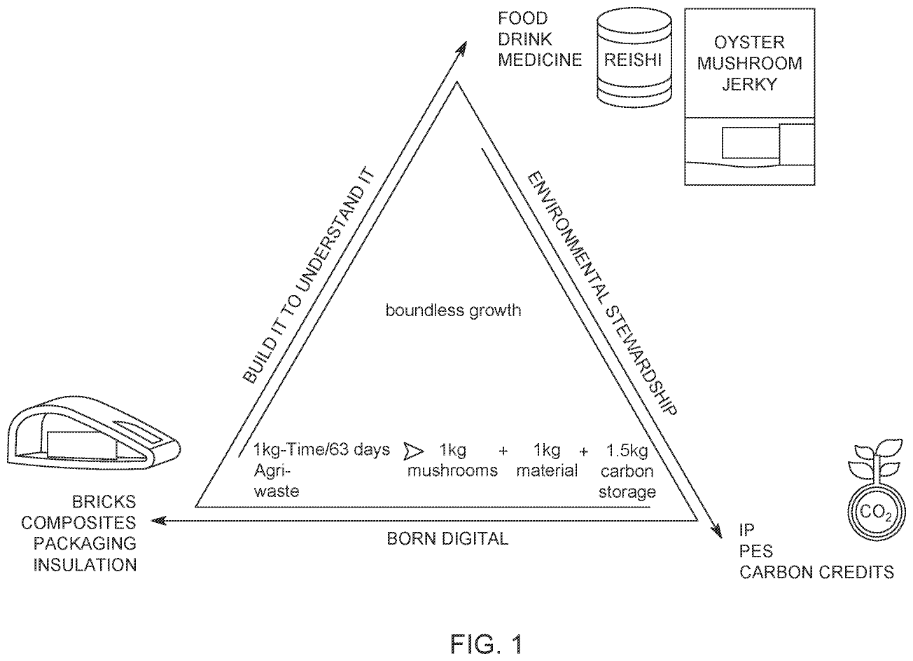

With the ability to produce nutritious, delicious food in a process that also creates structurally sound and sound and heat insulative construction composite materials in an integrated workflow with modular and adaptive aspects, one may recognize the central role of the fungus and the tri-partite by product dynamics where each apex of a “mycotriangle” is the byproduct of the other two apexes (see FIG. 1). The present invention is advantageous in that doing all three end points as part of an integrated process becomes self-sustaining financially and iteratively optimized as it goes, while enabling the generation of payment for ecosystem services, land-use improvements and carbon-offset credits by tracking the actions conducted in the production process securely online. In other words, the system produces a feed-forward, beneficial loop.

The system enables real-time data collection, utilizing bar coding and an interactive software application (app). For example, each batch of mycelium may be assigned a unique identification (ID). The app may be editable and self-propagating. The app may have any combination of features selected from the group consisting of: a Location Based Service; Offline Functionality; a Time Stamp; Photo/Video Capture; e-Signature; a Role-based View; Alerting/Notification; quick response (QR) Code Scanning; optical character recognition (OCR); near field communication (NFC) Reading (i.e., contactless); and Internet of Things (IoT) integration.

Optionally, measurements of physicochemical properties such as relative humidity, atmospheric pressure, pH, temperature, air quality and heat flows (e.g., using Forward Looking Infrared [FLIR] enabled sensors) can be used to annotate processes for additional insight generation into potential for improvement and understanding some of the fundamental physical, biological, and chemical processes at play during all phases of the operation.

Data collected according to an embodiment of the present invention may be stored utilizing distributed ledger technology, i.e., blockchain, making the data traceable and verifiable, producing a chain of evidence, establishing trust, e.g., in the safety of the food, and supporting operational excellence, e.g., with respect to certifications, while collecting the minimum data necessary to achieve these goals. The system is adaptive and conducive to rapid scaleup.

The present subject matter allows the operator for the first time to control in-situ production of different products determined by the results of basic if/then logic decisions responsive to the physicochemical and climate conditions, some of which may be molecular and mushroom species-specific, including but not limited to pH, temperature, light, applied heat, and pressure determining the structural and other physicochemical parameters intermediate and final products.

Key to this is the tri-partite “MycoTriangle” approach allowing a variety of endpoints as byproducts of each other including: food, drink, and medicine; bricks, composites, packaging, fire-retardant/sound attenuating insulation; and the digital documentation of these processes allows for the establishment of environmental stewardship products such as carbon credits and payments for ecosystem services integrated into a comprehensive, carbon negative system. Additional applications include mycoremediation such as water and industrial waste treatment, activated biochar functionalized with mycelium tea, mycopesticides, textiles and leather replacements.

Mycelium tea is produced as a byproduct of compressed mycotecture bricks. Without being bound by theory, in combination with biochar (a pyrolyzer byproduct), mycelium tea is believed to be the world's best fertilizer, especially coveted by high-value crop farmers such as those involved in cannabis production.

In some embodiments, a methodology described herein enables alignment among data, processes, products, and operational excellence. This is the first data collection methodology managing products from three completely separate industries simultaneously: Agriculture (Mushroom), Construction (Building Materials), and Financial Services (Carbon Credit). Taking into consideration the data acceptance standards and requirements from all three industries, the inventive method makes sure that the data collected is accepted by and satisfies all three disciplines. This greatly reduces the cost for the business to apply for certification and qualification.

The method establishes a living process core model driven by data to provide decision makers with an end-to-end view of the process from the data perspective. It demonstrates what control the business has over the processes of making all the products. It also provides insights for the business to constantly improve the processes, making the business leaner. Due to the clarity of the data relationship, the business may make an evidence-based informed decision on whether collection of certain types of data add value and what disruption, if any, may be caused to other products/processes if selected data collection stops.

The inventive method utilizes data mapping and data multiplexing to ensure decisions made across all product lines are based on a single set of data collected and measured with the same set of protocols and standards. The data mapping methodology also greatly reduces auditing and compliance risk. For example, data mapping enables combination of data related to food safety guidelines and carbon credits into a unitary process. The map is an effective and cost-efficient data solution that allows the business to only collect the data that matters, eliminating collecting meaningless data and wasting resources.

The methodology clearly maps out a matrix between function and data points. The mapping methodology gives the business a deep understanding of the logical relationship among all data points, so that a digital solution may be designed knowing what “core data” must be collected/protected for business continuity and what data have a higher tolerance to disruption. The methodology enables the business to iteratively prioritize development of an app and to invest in an iterative manner. With the guidance of the methodology, the business may develop a minimal viable product which satisfies the needs for productivity improvement and quality assurance.

In some embodiments, (distributed) machine vision and machine olfaction may be used as part of a suite of biosensing and chemosensing mechanisms to feed data in real time into development and optimization models. These models may use “sensor fusion” i.e., combining the output of several, possibly asynchronous measurements across different modalities to inform iterative optimization. For instance: noticing that Reishi mushrooms grow at their fastest rate when the tips are white and start slowing down as the tips change to yellow and darker oranges and browns can be tracked with machine vision, including by collecting periodic pictures or monitoring the colors using webcams, (remotely) operated and read by humans or automation, may be used to determine the optimal time to harvest. Monitoring the Volatile Organic Compounds (VOC) and the emergent scent characteristics using machine olfactors such as, for instance, those described in U.S. Pat. No. 9,140,677 B2 to Mershin et al., is a complementary or alternative approach to same result. The disclosure of U.S. Pat. No. 9,140,677 B2 is hereby incorporated by reference in its entirety.

The VOC and emergent scent characteristics available from a machine olfactor may be mined for tell-tale signals that correlate to fluctuations in growth speed as determined by machine vision. In this case, the two approaches together may be used to not only ensure fidelity of decisions but also to uncover the underlying mechanisms and response pathways. This approach benefits from timestamping and correlating disparate data streams from various parts of the process into one whole metric that facilitates iterative optimization and real-time decision making, such as what temperature and relative humidity to set, when to harvest, and when to halt growth due to contamination or disease that lead to yield decrements.

Air quality, relative humidity (RH), and temperature (T), as well as air circulation, are monitored and/or maintained for mixing spawn with substrate, spawn inoculation, and fungal genetics work. Homogeneity of temperature and relative humidity, airflow control, and contamination detection all leverage blockchain backed data collection (and vice versa). Air quality measurements using, for instance, a portable, handheld, smartphone-based Volatile Organic Compound sensor connected to the internet (e.g., a smartphone with an integrated thermal camera, such as the FLIR® Cat S61 air quality and heat flow sensor-enabled smartphone, connected wirelessly) may be used to produce actionable data in real-time as conditions in the clean mix room change, alerting the user to the presence of unacceptable Parts Per Million air quality, deviations from appropriate humidity and temperature conditions, and identification of “dead air” spots.

Slabs can be made that may be configured into many types of architecture including prefab housing.

In some embodiments, a cart system is provided for space optimization. Utilizing the cart's wheels, curing, monitoring, and other processes may be accomplished by simply moving the trays around the facility at the different stages of growth, harvesting, and production, limiting waste and facilitating cleaning. While the fruiting body growth on the top of tray contents may be sliced off and sent to processing, the mycelium composite in the bottom part of the tray may be compressed with a large-format (heated) platen press. Trays allow for easy autoclaving.

Taken together, an exemplary site may be designed to maximally leverage the availability of IoT and iterative optimization methods dependent on real-time data collection from a plurality of sources and methods. This allows for dynamic reconfiguration depending on type of operation and conditions, enabling co-location of several species growing on various substrates with minimal cross-contamination. The danger of outside contamination may be lowered by having moveable curtain separators and managing airflows such that spores can be kept in check. Pest infestations may be detected early or altogether avoided by lowering the difficulty in autoclaving and cleaning surfaces, reusable metal trays, and instruments. Coupling these flexible, adaptable, and reconfigurable designs results in efficient manufacturing of prefabricated construction materials beyond bricks, as well as household objects, and consumer products of various form factors. An important aspect of this methodology is the real-time collection of data and its correlation across time, with the eventual yields and material properties achieved. Having the ability to “look back in time” and see what conditions prevailed during the inoculation, colonization, fruiting, harvesting, pressing, and curing steps informs the iterative optimization of parameters by a closed feed-forward loop.

Utilizing even a small fraction of an invasive plant that grows in Namibia, known as encroacher bush, mycelium may be grown with little water and energy to produce an equivalent mass of food and an equivalent mass of construction material, while capturing a little more than twice its mass in CO₂ equivalent. Namibia has about 330 million tons of biomass that can be sustainably harvested every 15 years. Using only 0.7% of that amount, or about 2 million tons of biomass, the inventive process can produce 2 million tons of mushrooms and 2 million tons of structural block, sometimes referred to herein as “mycoblock”. The process can be represented by the following formula, in parts by weight:

2 parts biomass+3 parts H₂O+O₂→2 parts mushroom+2 parts mycoblock+1 part H₂O+CO₂

The mycoblock captures carbon in an amount of about 60% of the block's weight, a carbon dioxide equivalent of about 22 kg per 10 kg of mycoblock, according to the following equation.

10 kg×60%×3.67 cg CO₂e/kg=22 kg CO₂e

If a home contains 2000 mycoblocks, the home's construction captures 44 metric tons of carbon dioxide equivalent. In contrast, a concrete block having the same weight stores no carbon and its production produces no food. Both types of blocks exhibit a compression strength of about 26 Mpa. A concrete block has a density of about 2.1 g/m³ whereas a mycoblock has a density of about 0.64 g/cm³, making the mycoblock a much lighter construction material.

Referring now to FIGS. 1 through 11, FIG. 1 illustrates an integrated data management system according to an embodiment of the present invention that iteratively optimizes production of several different types of products as well as environmental stewardship. The side of the triangle rising from left to right represents data collected in the process of growing mushrooms for food, drink, and medicine. This data contributes to data collection and management regarding standards and certification, such as carbon credits, represented by the side of the triangle descending from left to right. The latter data contributes to data collection and management with respect to production of mycotecture products including bricks, composites, packaging, and insulation, represented by the horizontal side of the triangle. As noted, 1 kg of agriwaste over a period of 63 days may produce 1 kg of mushrooms, 1 kg of mycotecture products, and 1.5 kg of carbon storage.

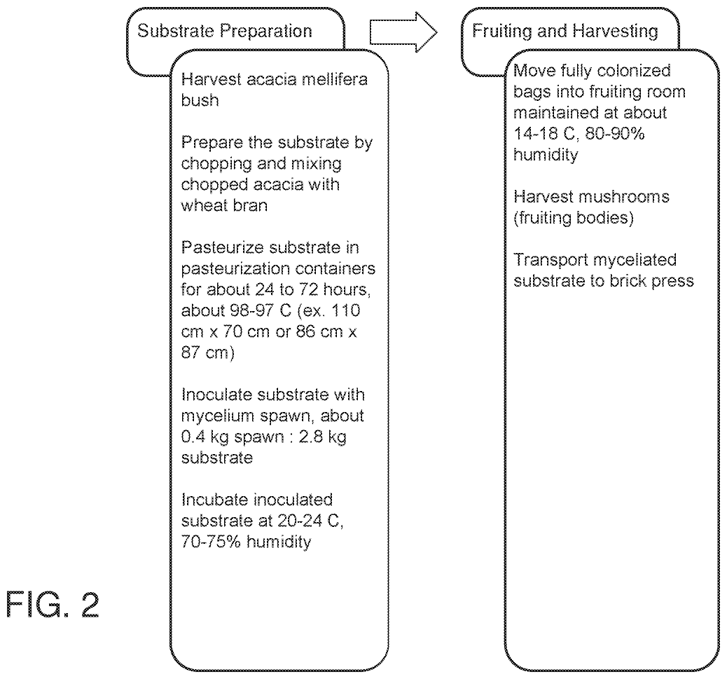

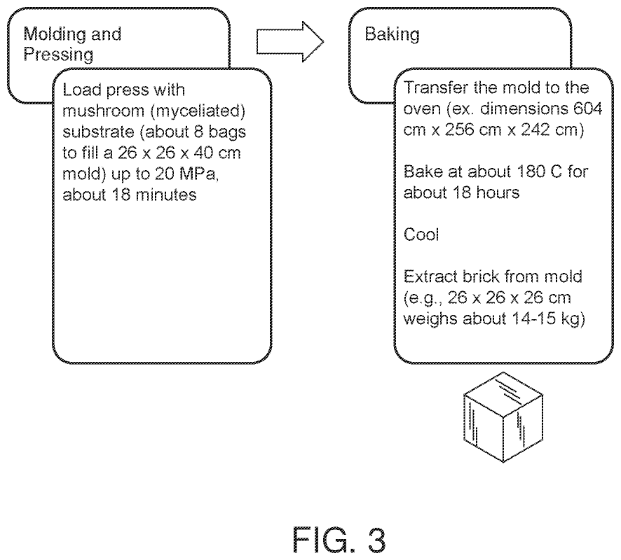

FIGS. 2 and 3 are flow diagrams of a mycotecture production process according to an embodiment of the present invention. As disclosed in FIG. 2, a method of substrate preparation according to an embodiment of the present invention begins with harvesting agriwaste, such as acacia mellifera bush. The harvested agriwaste may be chopped and mixed with wheat bran to produce a growth substrate. The substrate may be pasteurized for about 24 to 72 hours, at about 98-97° C. in a suitable container. For example, the container may have dimensions of about 110 cm×70 cm or of about 86 cm×87 cm. The substrate may be inoculated with mycelium spawn at a ratio of about 0.4 kg spawn:2.8 kg substrate and may be incubated at about 20-24° C. and about 70-75% humidity. The process shifts to a fruiting and harvesting function, in which the fully colonized bags are moved into a fruiting room maintained at about 14-18° C. and about 80-90% humidity. Once the fruiting bodies, i.e., mushrooms, emerge, they are harvested and the remaining myceliated substrate may be transported to a brick press.

Turning to FIG. 3, the molding and pressing step comprises loading the press with the myceliated substrate and pressing the substrate at a pressure of up to 20 MPa for about 18 minutes. For example, the mold may have dimensions of 26×26×40 cm. The mold containing compressed myceliated substrate may then be transferred to an oven for baking at about 180° C. for about 18 hours. An exemplary oven may have dimensions such as about 604 cm×256 cm×242 cm. The mold may be cool prior to extraction of a brick from the mold. The resulting brick may have dimensions of e.g., about 26×26×26 cm and weigh about 14-15 kg.

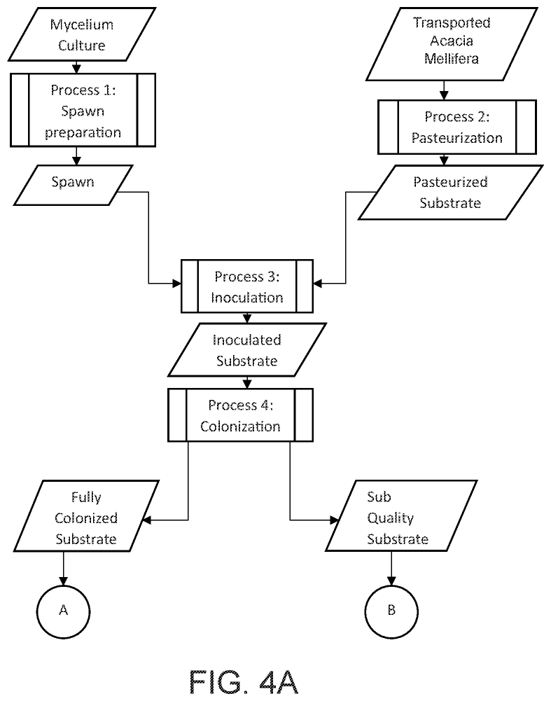

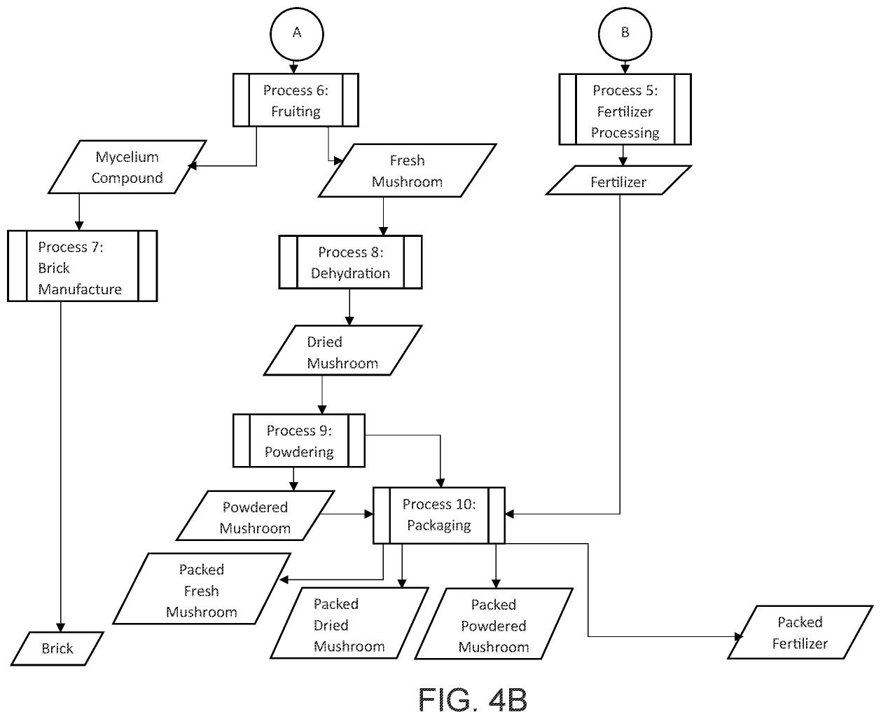

FIGS. 4A and 4B together are a process map presenting the process flow in distinct process groupings 1 through 10, identified as follows. (1) Spawn preparation. (2) Pasteurization. (3) Inoculation. (4) Colonization. (5) Fertilizer processing. (6) Fruiting. (7) Brick manufacture. (8) Dehydration. (9) Powdering. (10) Packaging. Products include brick, packed fresh mushroom, packed dried mushroom, packed powdered mushroom, and packed fertilizer.

As shown in Table 1, the overall process provides a wide variety of products, byproducts, and functional advantages spanning several industrial sectors.

TABLE 1
Cultivation

| | Mushrooms: | | | | | | | | |
|---|---|---|---|---|---|---|---|---|---|
| Mycelium Spore | Food & Health | Mycelium Composite Material | | | | Packaging | Bioremediation | | |
| Supply premium mycelium | Commercial | Commercial & building grade mycelium | | | | Commercial | A combination of Mycelium, plants | | |
| spore globally: Oyster, | local & | composite material for: | | | | packaging | & other ameliorants to rehabilitate | | |
| Reishi, other exotic | international | | | | | materials | contaminated water, land, materials | | |
| mycelium species that | grade for sale | Building | Insulation/ | Fittings/ | Other | Various | Mycore- | Phytore- | BioChar/ |
| have | to various | Materials | Soundproof | Furniture | | packaging | mediation | mediation | Other |
| commercial/industrial; | industries: fresh; | | | | | materials | | | |
| health & bioremediation | dried; powdered; | Bricks/ | Panels | Furniture | Art | Polystyrene | Myco | Plants | Activated |
| value | other - tea/ | Blocks | | | | replacement | Forestry | | Biochar |
| | coffee, health | Boards | Boards | Fittings | Leather | Waterproof | Myco | Bamboo | Biochar |
| | powders | | | | | packaging | Filtration | | |
| | | Planks | Tiles | Doors/ | Promotional | Designer/ | Mycore- | Hemp | Compost/ |
| | | | | Frames | | High End | mediation | | Mulch |
| | | Molded | Other | Other | Textiles? | Plastic | Myco | Other | Mycelium |
| | | Forms | materials | | | replacement | pesticides | | “tea” |

Inherently sustainable & socially relevant: Impact by leveraging biotechnology, biotecture, bioremediation, solar/renewable energy.
Blockchain/Crypto Ecosystem System Services Markets: Carbon credits/Offsets with co-benefits, water, biodiversity, etc.
Born Digital, Data Led: Digital, Data, IoT, Blockchain/DLT; Analytics/AI/ML, etc.

Each step of the process has several variables for which data may be collected and analyzed, as shown in Table 2.

TABLE 2

| | | | | | | | Lo- | | | | | Temp- | | Trans- | | |
|---|---|---|---|---|---|---|---|---|---|---|---|---|---|---|---|---|
| Input/Output | | Bag | Cleaning | Cost | Labor | Light | cation | Power | Pressure | Sales | Storage | erature | Time | port | Water | Weight |
| Colonization of | | | | | ✓ | ✓ | | ✓ | | | | ✓ | ✓ | | ✓ | |
| Inoculated Substrate | | | | | | | | | | | | | | | | |
| Fruiting Colonized | | | | | ✓ | | | ✓ | | | | ✓ | ✓ | | ✓ | |
| Substrate | | | | | | | | | | | | | | | | |
| Harvesting Fresh | | ✓ | | | ✓ | ✓ | | | | | | ✓ | | | | ✓ |
| Mushroom | | | | | | | | | | | | | | | | |
| Inoculation of Acacia | | ✓ | | | ✓ | | | ✓ | | | | ✓ | ✓ | ✓ | ✓ | ✓ |
| Mellifera | | | | | | | | | | | | | | | | |
| Inoculation of Spawn | | ✓ | | | ✓ | | | ✓ | | | | ✓ | ✓ | ✓ | ✓ | ✓ |
| Manufacture of | | ✓ | | | ✓ | | | ✓ | ✓ | | | ✓ | ✓ | | | ✓ |
| Mycelium compound | | | | | | | | | | | | | | | | |
| Processing | Dried | ✓ | ✓ | | ✓ | | | ✓ | | | ✓ | ✓ | | | | ✓ |
| & | Mushroom | | | | | | | | | | | | | | | |
| Storage | Fertilizer | ✓ | | | ✓ | | | | | | ✓ | | | | | ✓ |
| | Packed Dried | | | | | | | | | ✓ | ✓ | | | ✓ | | |
| | Mushroom | | | | | | | | | | | | | | | |
| | Powdered | ✓ | ✓ | | ✓ | | | ✓ | | | ✓ | | | ✓ | | ✓ |
| | Mushroom | | | | | | | | | | | | | | | |
| | Packed Fresh | | ✓ | | ✓ | | | ✓ | | ✓ | ✓ | | | | | |
| | Mushroom | | | | | | | | | | | | | | | |
| | MycoBrick | | | | | | | | | ✓ | ✓ | | | ✓ | | |
| Sales | Packed | | | | | | | | | ✓ | ✓ | | | | | |
| | Fertilizer | | | | | | | | | | | | | | | |
| | Packed | | | | | | | | | ✓ | ✓ | | | ✓ | | |
| | Powdered | | | | | | | | | | | | | | | |
| | Mushroom | | | | | | | | | | | | | | | |
| Source | Acacia | ✓ | | ✓ | | | ✓ | ✓ | | | | ✓ | ✓ | ✓ | | ✓ |
| | Mellifera | | | | | | | | | | | | | | | |
| | Spawn | ✓ | | ✓ | | | ✓ | ✓ | | | | ✓ | ✓ | ✓ | | ✓ |

| | | |
|---|---|---|
| Sub Quality Substrate | ✓ | ✓ |

The data collection may be optimized by evaluating a matrix of variables with respect to the purposes of collecting data, as seen in Table 3.

TABLE 3

| | Brick | | | Fertilizer | | | | | | Spawn |
|---|---|---|---|---|---|---|---|---|---|---|
| | Manufacture | Colonization | Dehydration | Processing | Fruiting | Inoculation | Packing | Pasteurization | Powdering | Preparation |
| Bag | | | | N/A | | | 2, 4 | 2, 4 | | |
| Cost | 2 | 2 | 2 | N/A | 2 | 2 | 2 | 2 | 2 | 2 |
| Duration | 2, 3, 4 | 1, 2, 3, 4 | 1, 2 | N/A | 1, 2, 3, 4 | 1, 2, 3, 4 | 1, 2 | 1, 2, 3, 4 | | 1, 2, 3, 4 |
| Humidity | 2, 3 | 1, 2, 3, 4 | 1, 2 | N/A | 1, 2, 3, 4 | | | | | |
| Labor | 2 | 2 | 2 | N/A | 2 | 2 | 2 | 2 | 2 | 2 |
| Light | | 1, 2, 3, 4 | | N/A | 1, 2, 3, 4 | | | | | |
| Location | 2, 3, 4 | 1, 2, 3, 4 | 1, 2 | N/A | 1, 2, 3, 4 | 1, 2, 3, 4 | 1, 2 | 1, 2, 3, 4 | 1, 2 | 1, 2, 3, 4 |
| Power | 2, 3, 4 | 2, 3, 4 | 2, 4 | N/A | 2, 3, 4 | 2, 3, 4 | | 2, 3, 4 | 2, 4 | 2, 3, 4 |
| Pressure | 2, 3, 4 | | | N/A | | | | | | |
| Quantity | 2, 3, 4 | 1, 2, 3, 4 | 1, 2 | N/A | 1, 2, 3, 4 | 1, 2, 3, 4 | 1, 2, 4 | 1, 2, 3, 4 | 1, 2 | 1, 2, 4 |
| Sales | N/A | N/A | N/A | N/A | N/A | N/A | N/A | N/A | N/A | N/A |
| Storage | 2, 3 | | | N/A | 1, 2, 3 | | 1, 2 | | | 1, 2, 3 |
| Supplier/ | N/A | N/A | N/A | N/A | N/A | N/A | N/A | N/A | N/A | N/A |
| Customer | | | | | | | | | | |
| Temperature | 2, 3, 4 | 1, 2, 3, 4 | 1, 2 | N/A | 1, 2, 3, 4 | 1, 2, 3, 4 | 1, 2 | 1, 2, 3, 4 | 1, 2 | 1, 2, 3, 4 |
| Time | 2, 3, 4 | 1, 2, 3, 4 | 1, 2 | N/A | 1, 2, 3, 4 | 1, 2, 3, 4 | 1, 2 | 1, 2, 3, 4 | 1, 2 | 1, 2, 3, 4 |
| Transportation | N/A | N/A | N/A | N/A | N/A | N/A | N/A | N/A | N/A | N/A |
| Water | 2, 3, 4 | 1, 2, 3, 4 | | N/A | 1, 2, 3, 4 | | | 1, 2, 3, 4 | | 1, 2, 3, 4 |
| Weight | 2, 3, 4 | 4 | 1, 2 | N/A | 1, 2, 3, 4 | 1, 2, 3, 4 | 1, 2 | | 1, 2 | 1, 2, 3, 4 |

1: Food Traceability
2: Operational Excellence
3: Bricks Certification
4: Carbon Credit

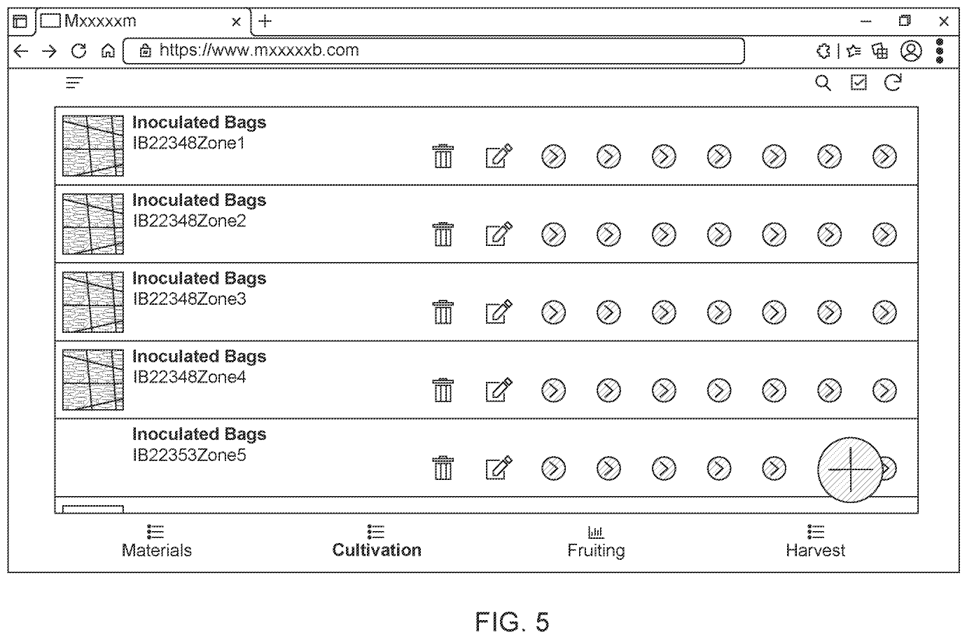

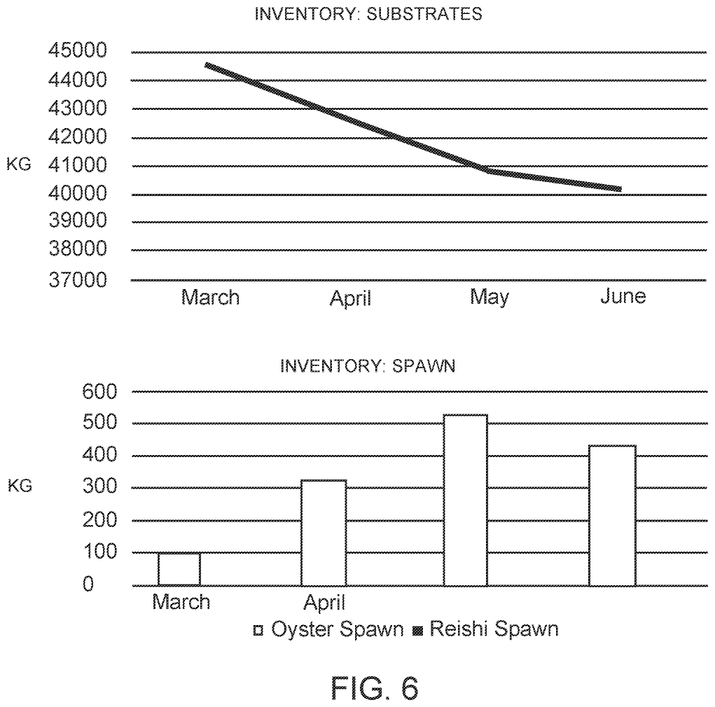

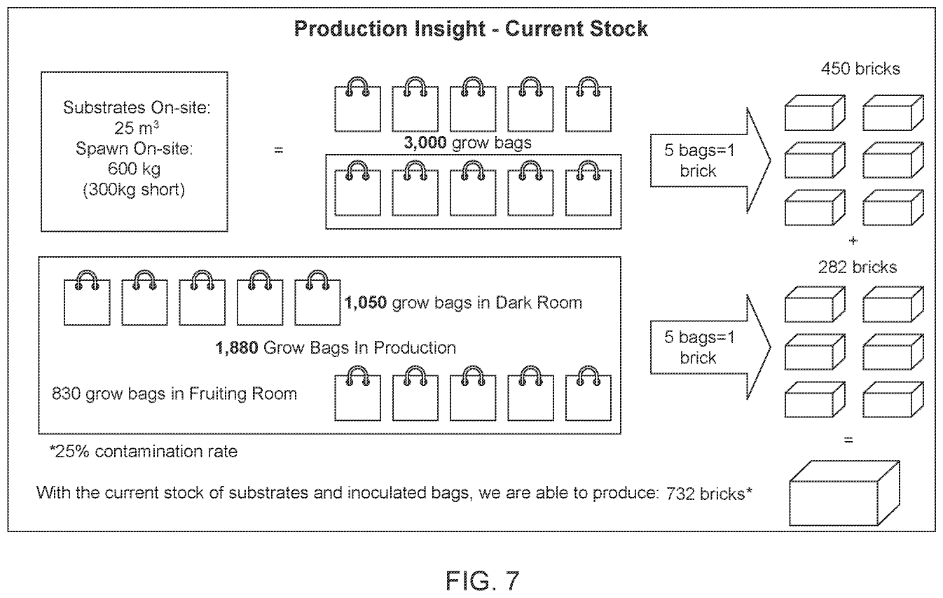

An app according to an embodiment of the present invention may be used to collect, track, and analyze these data. A user interface of the app for data collection is shown in FIG. 5. Data may be tracked throughout cultivation, fruiting, and harvest, as well as throughout materials production from the initial inoculated substrate batch. The app may monitor data relationships and process the data to produce charts on a dashboard such as seen in FIG. 6, and report insights gleaned from the data, as shown in FIG. 7.

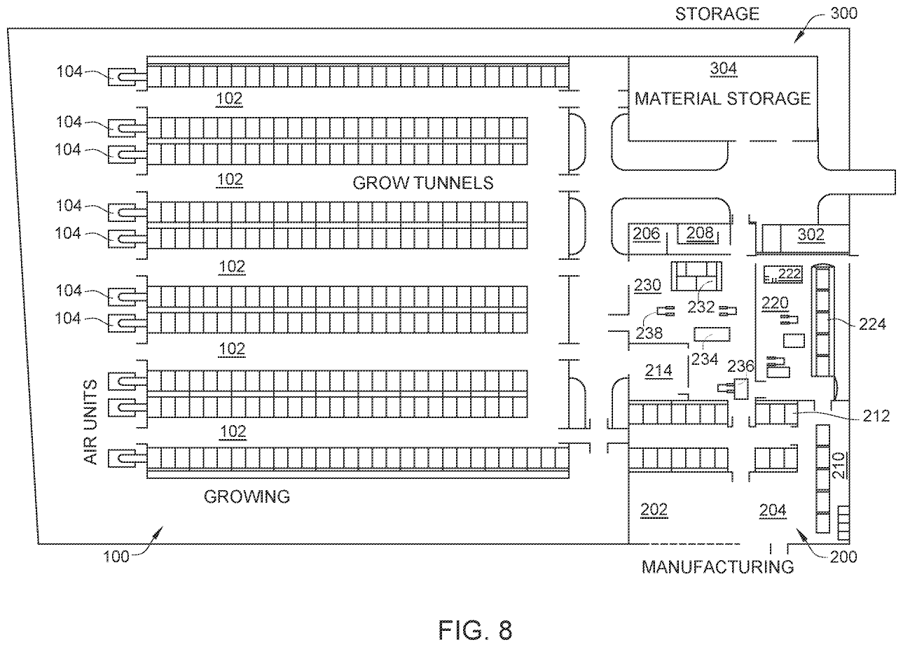

A floor plan of a growing/manufacturing facility utilizing a system according to an embodiment of the present invention is illustrated in FIG. 8. The facility comprises a growing section 100 with grow tunnels 102 fed by air units 104, a manufacturing section 200, and a storage section 300. The growing section 100 may have an area of, for example, about 2500 m², in which conditioned tunnels 102 house carts 110 of mycelium-inoculated substrate composite. The storage section may have an area of about 250 m², or about 1/10th of the area in the growing section, housing bulk substrate storage 302 and building material storage 304. The manufacturing section may have an area of about 1000 m², or about 4 times the area in the storage section. The manufacturing section 200 may house a lab 210 and inoculation area, a clean room 220 housing clean trays, a mixer 222, and an autoclave 224, a mushroom processing room 214, a press room 230 with a slab, board, or laminating press 232, a slab or compacting press 234, and band saw(s) 236, 238, and a locker 206 with rest rooms 208, as well as offices 202 and a reception area 204. An observation area 212 may also be present. 218, 226, 228 240-298

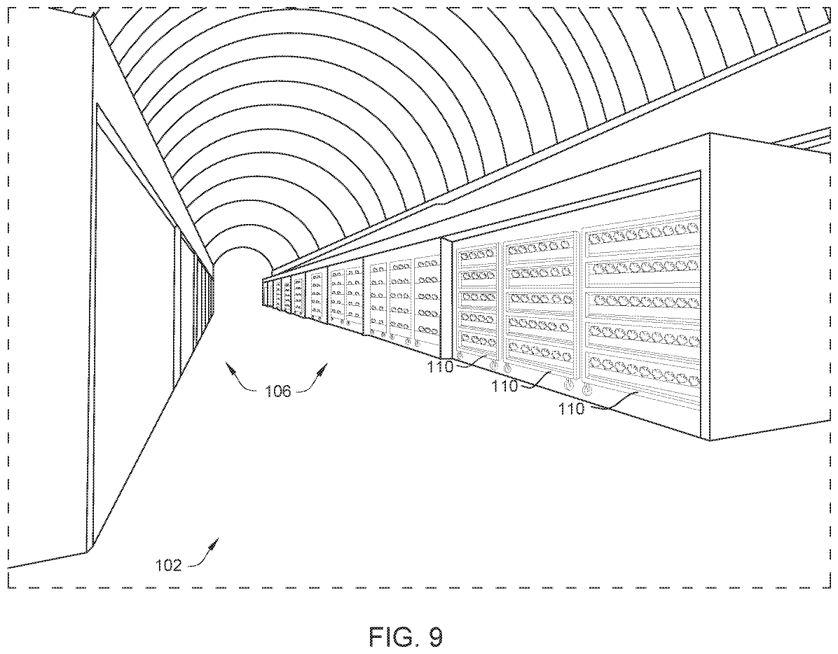

A growing tunnel is illustrated in FIG. 9, having rows of ‘incubators’ 106 housing carts 110 with trays 112 of inoculated substrate under selected temperature, humidity, airflow, and air quality conditions.

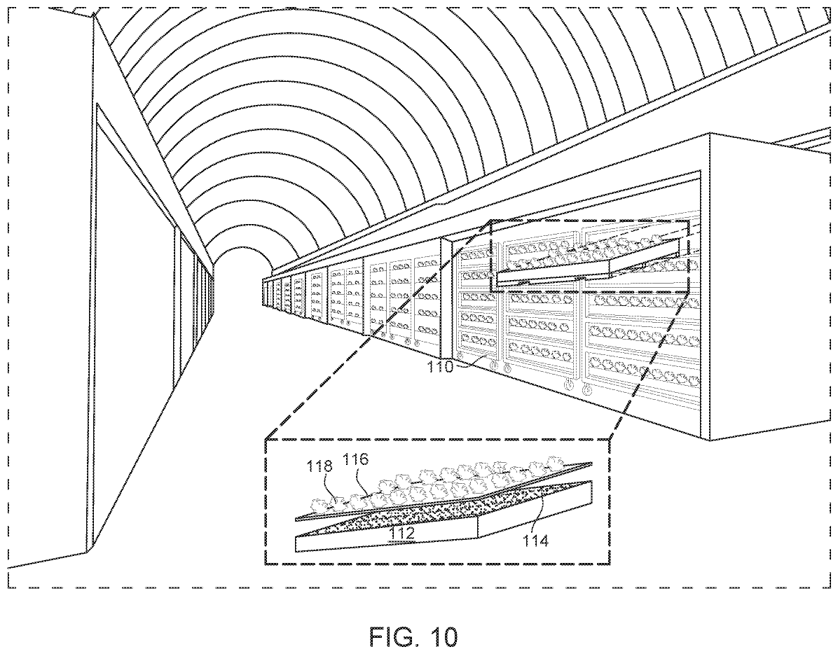

A cart system 110 that may be used throughout the facility is shown in FIG. 10. The carts 110 hold a column of trays 112 which support the substrate from inoculation to harvesting, at which point the top layer 116 comprising fruiting bodies 118 may be sliced off and delivered to the mushroom processing room 214 and the remaining composite 114 may be pressed to form a slab and mycelium ‘tea’ in a press room 230. The trays 112 are reusable, easily washable, autoclavable, and limit waste as well as the volume of air that must be conditioned. The trays 112 are prepared in a clean room 220 which contains a mixer 222 and autoclave 224. The lab 210 monitors conditions and quality in each of the manufacturing steps and determines iterative improvements that may be made to the process.

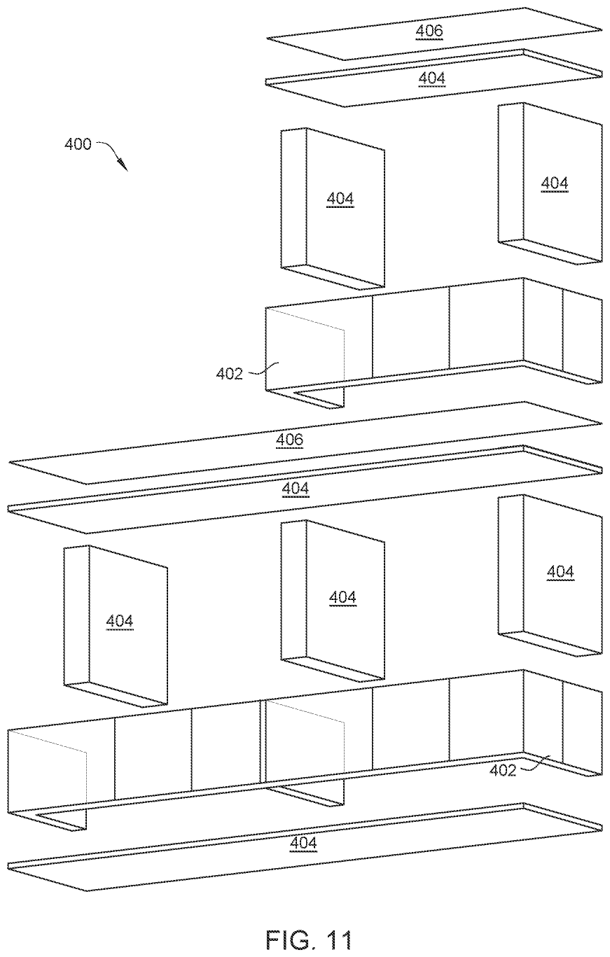

The slabs 404 formed in the facility may be configured into a variety of shapes and may be used, for example, in prefab housing 400 as well as other architectural structures. See FIG. 11. The slabs 404 are light, strong, and lend themselves to minimizing the parts necessary for assembly, reducing costs. The slabs 404 may be augmented with commercially available building components, such as waterproof membranes 406 and triple pane glass. The slabs 404 are sufficiently strong to support a glass ‘curtain’ wall 402 with sliding openings. The slabs 404 may also be ‘upcycled’ for a longer service life.

It should be understood, of course, that the foregoing relates to exemplary embodiments of the invention and that modifications may be made without departing from the spirit and scope of the invention as set forth in the following claims.

What is claimed is:

1. A data collection and analysis method operative to align data across processes and products, comprising:
collecting data in real time;
mapping the data to a matrix between function and data points; and
multiplexing the data.

2. The data collection and analysis method of claim 1, further comprising collecting machine olfactory data and machine vision data via a suite of biosensing and chemosensing mechanisms.

3. The data collection and analysis method of claim 1, further comprising correlating disparate data utilizing sensor fusion.

4. An integrated manufacturing process of a plurality of intermediate and final products from mycelium, comprising:
collecting data from the system at intervals;
analyzing the data;
iteratively optimizing the manufacturing process from the processed data; and
generating environmental certifications from the processed data.

5. An adaptive, unified mycotecture platform in conjunction with a digital recording and analysis system operative to monitor and iteratively optimize growth, harvest, packaging, quality control, and payment, comprising:
at least one manufacturing facility having a growing section, a storage section, and a manufacturing section, the facility having one or more components selected from the group consisting of sensors, rapid-deploy scaffolding, a reconfigurable press, a brick extractor, a mixer, an autoclave, a laboratory, bar coding, and an interactive software application.

6. The adaptive, unified mycotecture platform in conjunction with the digital recording and analysis system of claim 5, wherein the manufacturing facility contains a plurality of wheeled growing carts, each containing a column of growing trays.

7. The adaptive, unified mycotecture platform in conjunction with the digital recording and analysis system of claim 5, comprising sensors operative to monitor at least one condition selected from the group consisting of: air contamination, relative humidity, temperature, and air circulation.

8. The adaptive, unified mycotecture platform in conjunction with the digital recording and analysis system of claim 7, wherein the condition is air contamination and the sensor is a smartphone-based volatile organic compound sensor.
